(19) United States
(12) Patent Application Publication
(10) Pub. No.: US 2004/0185190 A1
(43) Pub. Date: Sep. 23, 2004

(54) Artificial winged insect

(76) Inventor: Larry Ralph Booth, Fox Point, WI (US)

Correspondence Address: Larry Randolph Booth, 220 East Clovernook Lane, Milwaukee, WI, 53217, US

(21) Appl. No.: 10/392,100

(22) Filed: Mar. 19, 2003

(51) Int. Cl. B32B 9/00

(52) U.S. Cl. 428/16; 428/15; 428/542.2

(57) ABSTRACT

An artificial insect comprises a body having a head end and a tail end. The body has an upper body section and a lower body section. The lower body section has an upper surface defining a cavity with opposite upwardly angled sidewalls. The upper body section has a lower surface that defines a pair of opposite upwardly angled sidewalls that are received within the cavity and cooperate with the sidewalls of the cavity in the lower body section to define a wing receiving slot. A one-piece wing component is disposed in the wing receiving slot between the lower body section and the upper body section and extends outwardly from opposite sides of the body. The upper body section is coupled to the lower body section, via a press-fit arrangement thereby firmly sandwiching the wing component between the upper body section and the lower body section.

### BACKGROUND OF THE INVENTION

The present invention relates to an artificial insect for use as a decorative display, and more particularly to an artificial butterfly for said purpose. Artificial insects may serve as decoration for a variety of indoor or outdoor settings such as for a residence or a commercial or retail establishment.

It is desirable for artificial insects, such as for example butterflies, to appear lifelike and have visual appeal. Live insects occurring in nature typically hold their wings at an upward angle from their bodies. Therefore, to enhance the lifelike, natural appearance of artificial insects, it is desirable to provide an artificial insect with wings that extend at an upward angle from the insect's body. At the same time, the artificial insect should be functional as decoration and the wings should be firmly supported by the body so that the insect is durable and capable of extended indoor or outdoor use.

To economically mass-produce artificial insects, it is desirable to minimize the number of components and complexity of construction required for manufacture. It is also desirable to provide insect bodies that are interchangeable with wings of various shapes and sizes.

### SUMMARY OF THE INVENTION

The present invention relates to an artificial insect that appears lifelike, and is durable. The insect is easily manufactured and includes a minimal number of parts.

The artificial insect comprises a body having a head end and a tail end. The body has an upper body section and a lower body section. The lower body section has an upper surface defining a cavity with opposite upwardly angled sidewalls. The upper body section has a lower surface that defines a pair of opposite upwardly angled sidewalls that are received within the cavity and cooperate with the sidewalls of the upper surface of the lower body section to define a wing receiving slot. A one-piece wing component is disposed in this slot between the upper body section and the lower body section. The one-piece wing component has left and right wing portions that extend outwardly from opposite sides of the body. The upper body section is coupled to the lower body section, preferably via a press-fit arrangement, to thereby sandwich the wing component between the upper body section and lower body section. The wing component is thus firmly secured to the body and due to the upwardly angled sidewalls the left and right wing portions extend at an upward angle, providing a simply constructed insect having a lifelike appearance.

In a preferred embodiment, the press-fit arrangement comprises at least one peg depending from the upper body section and at least one peg-receiving bore formed in the lower body section. The peg extends through an aperture formed in the wing component and is press fit into the bore to firmly secure the upper body section to the lower body section and sandwich the wing component therebetween.

### BRIEF DESCRIPTION OF THE DRAWINGS

FIG. 1 is a top plan view of an artificial insect constructed in accordance with a preferred embodiment of the present invention.

FIG. 2 is an exploded perspective view of the artificial insect of FIG. 1.

FIG. 3 is a side view of the upper body section.

FIG. 4 is a bottom view of the upper body section.

FIG. 5 is a side view of the lower body section.

FIG. 6 is a top view of the lower body section.

FIG. 6A is a sectional view of the upper and lower body sections taken along line A-A shown in FIG. 6.

FIG. 7 is a front perspective view of the artificial insect without its one-piece wing component.

FIG. 8 is a top plan view of the one-piece wing component.

### DETAILED DESCRIPTION OF THE PREFERRED EMBODIMENT

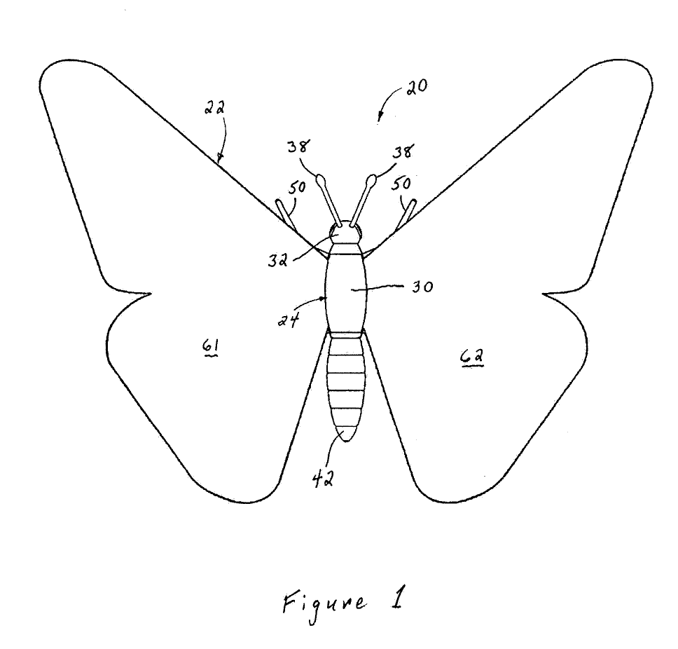

FIG. 1 depicts a preferred embodiment of an artificial insect 20 of the present invention. The artificial insect 20 is preferably formed in the shape of a butterfly having a one-piece wing component 22 and a body 24. The body 24 and wing component 22 may be formed in a variety of shapes and sizes to depict any typical flying insect, and thus although a butterfly is illustrated and described herein, the invention is applicable to construct numerous other insects. Also, the body 24 and wing component 22 may be constructed of various types of plastic and therefore may be easily manufactured for relatively low cost.

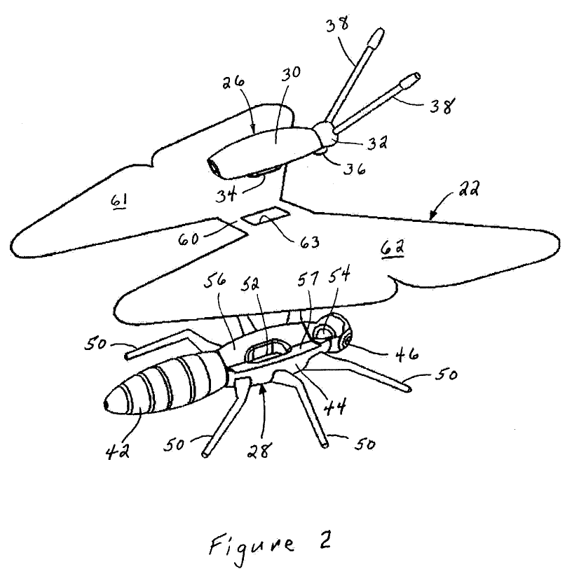

As can be seen in FIG. 2, the body 24 consists of two parts, namely an upper body section 26 and a lower body section 28. The upper body section 26 is coupled to the lower body section 28 via a press-fit arrangement, to thereby sandwich the one-piece wing component 22 between the upper body section 26 and the lower body section 28. As described further below, the wing component 22 is firmly secured to the body 24 and has a left wing portion 61 and a right wing portion 62 that extend from body 24 at an upward angle, thus giving insect 20 a lifelike appearance.

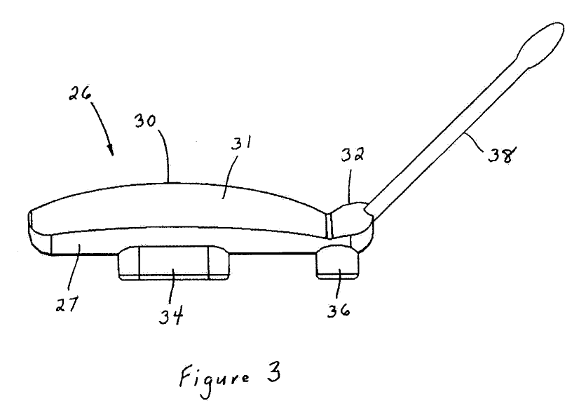

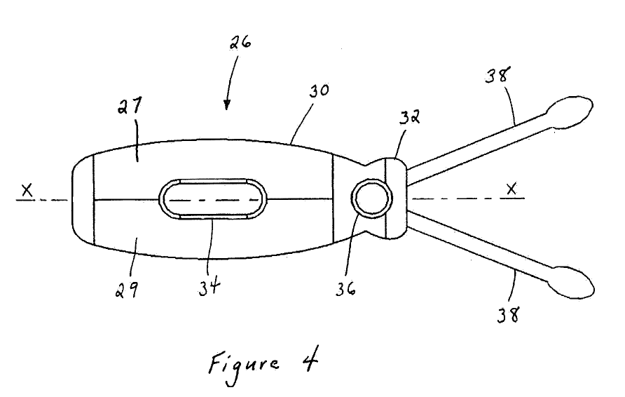

As shown in FIG. 3, the upper body section 26 is formed as one piece and has an upper thorax section 30 and an upper head section 32. As shown in FIGS. 3, 4 and 6A, the upper thorax section 30 has an upper surface 31 which is arcuate-shaped in cross section and a lower surface comprising a pair of opposite, planar, upwardly angled sidewalls 27, 29. The upper body section 26 also has a first peg 34 depending or projecting downwardly from the lower surface of upper thorax section 30 and a second peg 36 projecting from or depending downwardly from the lower surface of the upper head section 32. As is shown more clearly in FIG. 4, the first peg 34 is elongated or oval-shaped in cross section along an axis X-X, and the second peg 36 is substantially circular in cross section. It should be noted that although peg 34 is illustrated as being oval-shaped, and peg 36 as being circular in cross section, they may be configured to have other shapes, e.g. square, rectangular, or polygonal, so long as they function to provide for securing upper body section 26 to lower body section 28, as will hereinafter be described. The upper body section 26 also has a pair of antennas 38 that extend forwardly and outwardly from the upper head section 32.

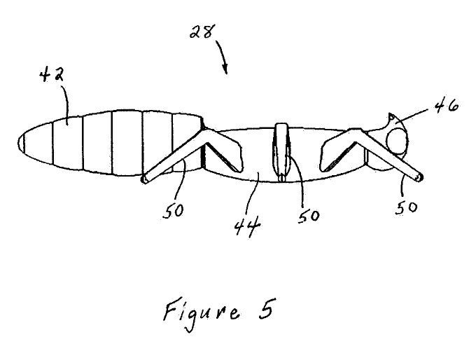

Referring now to FIG. 5, the lower body section 28 has an abdomen 42, a lower thorax section 44 and a lower head section 46. The lower body section 28 also has a total of six legs, i.e. three legs 50 extending from each of the opposite sides of the lower thorax section 44, as shown best in FIGS. 2, 6 and 7. The legs 50, lower head section 46, lower thorax section 44 and abdomen 42 are preferably all integrally formed as a one-piece injection molded part.

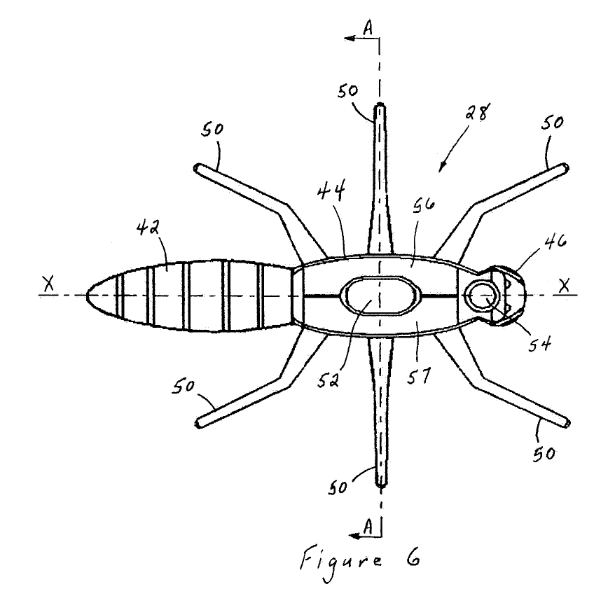

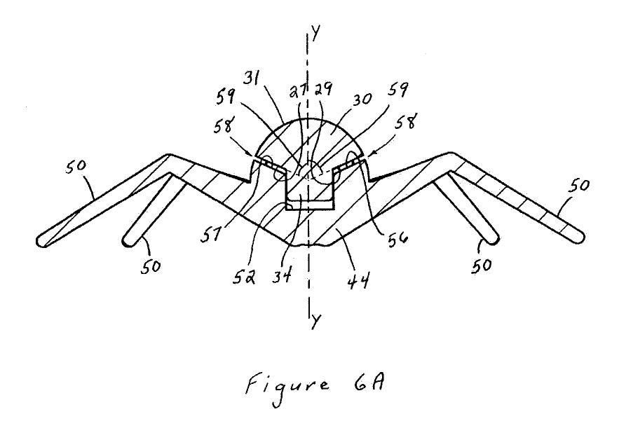

As shown best in FIGS. 2, 6 and 6A, the upper surface of the lower thorax section 44 and lower head section 46 defines a recessed cavity that is sized and configured to receive the lower surface of the upper body section 26. Also, the recessed cavity includes a first oval-shaped bore 52 formed in lower thorax section 44 which is sized slightly larger than the first peg 34 and a spaced second circular bore 54 formed in lower head section 46 sized slightly larger than the second peg 36. The first bore 52 is elongated along the axis X-X and the second bore 54 is substantially circular in cross section so that they substantially match the cross sectional configurations of pegs 34 and 36, respectively. The first and second pegs 34, 36 may thus be press-fit into the first and second bores 52, 54, respectively, to firmly couple the upper body section 26 to the lower body section 28 to define a wing-receiving slot 58 (shown best in FIG. 6A). As is discussed below, the one-piece wing component 22 is sandwiched between the upper body section 26 and the lower body section 28 within slot 58.

FIG. 6A depicts a sectional view taken through the upper thorax section 30 and the lower thorax section 44 along line A-A shown in FIG. 6. As shown, the recessed cavity in lower thorax section 30 has opposite upwardly angled sidewalls 56 and 57 that extend parallel to the upwardly angled sidewalls 27, 29 of the upper thorax section 30 when the upper body section 26 is coupled to the lower body section 28. Walls 56, 57 oppose walls 27, 29 to thereby define wing-receiving slot 58. The preferred angle 59 of the opposing angled sidewalls 56, 57, 27, 29 is 65° from the vertical axis Y-Y. The angle 59 may be any angle desired, such as an acute, obtuse or right angle.

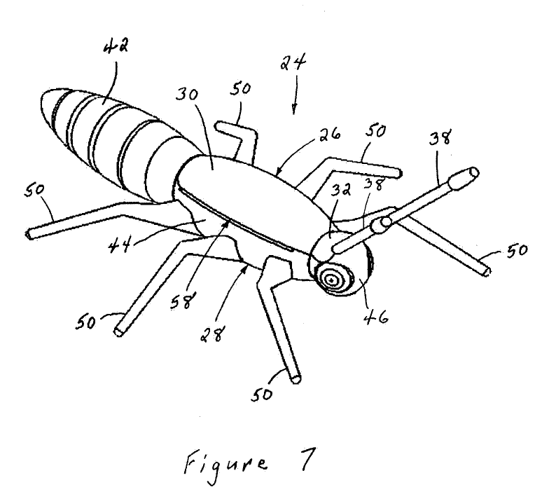

As shown in FIGS. 6A and 7, when upper body section 26 is press fit into the lower body section 28, the pair of upwardly angled sidewalls 27, 29 on the upper thorax section 30 and the pair of upwardly angled sidewalls 56, 57 on the lower thorax section 44 form a wing receiving slot 58 disposed at an upward angle from the body 24. Therefore, when the one-piece wing component 22 is sandwiched between the upper body section 26 and the lower body section 28, the left wing portion 61 and right wing portion 62 of wing component 22 extend from the body 24 through the wing receiving slot 58 at the same upward angle.

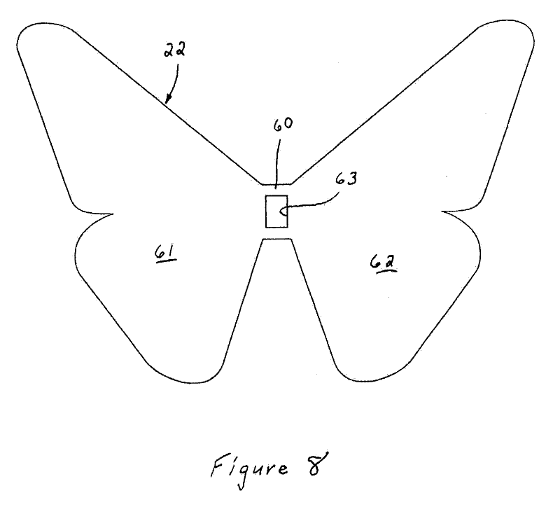

As shown in FIG. 8, the wing component 22 is formed as an integral one-piece structure having a left wing portion 61 and a right wing portion 62 joined by a bridge section 60. The bridge section 60 has an aperture 63 sized to allow the first peg 34 depending from the upper body section 26 to pass therethrough. Thus, when the first peg 34 extends through aperture 63 and is press-fit into the first bore 52, the wing component 22 is securely positioned between the upper body section 26 and the lower body section 28. As stated above, the left wing portion 61 and right wing portion 62 of the wing component 22 extend at a desired angle (such as 65° for a butterfly) from the wing receiving slot 58 thus providing a natural appearance for the insect 20. The wing component 22 preferably comprises a plastic film, e.g. polyester or vinyl and has print formed on both upper and lower surfaces thereof representing various actual or imaginary designs for a butterfly. In the embodiment depicted, the wing component 22 is a generic design for a butterfly, but other insect wing designs are contemplated and may be constructed in accordance with the present invention.

The simple, yet unique construction of the body 24 and wing component 22 allows for easy manufacture and assembly of a lifelike butterfly. The unique construction of the body 24 also allows for different wing designs representing various butterfly species and/or other winged insects to be used with a single, generic body design.

While this invention is susceptible of embodiments in many different forms, the drawings illustrate and the specification describes in detail a preferred embodiment of the invention. It should be understood that the drawings and specification are to be considered an exemplification of the principles of the invention. They are not intended to limit the broad aspects of the invention to the specific embodiment illustrated.

I claim:

1. An artificial insect comprising:
a body having a head end and a tail end, said body having an upper body section and a lower body section and said lower body section having an upper surface defining a cavity with opposite angled sidewalls;
said upper body section having a lower surface received within said cavity that cooperates with said upper surface to define a wing-receiving slot;
a one-piece wing component disposed between said lower body section and said upper body section in said wing-receiving slot; and
a coupling arrangement joining said upper body section to said lower body section, and affixing said wing component therebetween.

2. The artificial insect of claim 1 wherein said body extends along a longitudinal axis and said wing component has a left wing portion and a right wing portion that extend from said slot at upward acute angles from a vertical plane extending through said axis.

3. The artificial insect of claim 1 wherein said coupling arrangement comprises a press-fit arrangement.

4. The artificial insect of claim 3 wherein said upper body has a peg depending therefrom and said lower body includes a bore formed therein, said peg being press-fit into said bore to secure said upper body section to said lower body section.

5. The artificial insect of claim 4 wherein said wing component has an aperture formed therein and said peg extends through said aperture, thereby sandwiching said wing component between said upper body section and said lower body section.

6. The artificial insect of claim 1 wherein said lower body section comprises an abdomen, a lower thorax section, and a lower head section, and said upper body section comprises an upper thorax section and an upper head section.

7. The artificial insect of claim 6 wherein said coupling arrangement comprises:
a first peg depending from said upper thorax section;
a second peg depending from said upper head section;
a first bore formed in said lower thorax section; and
a second bore formed in said lower head section, wherein said first peg is press fit into said first bore and said second peg is press fit into said second bore to couple said upper body section to said lower body section.

8. The artificial insect of claim 7 wherein said wing component has an aperture formed therein and said first peg extends through said aperture, thereby sandwiching said wing component between said upper body section and said lower body section.

9. The artificial insect of claim 7 wherein said first peg and said first bore are substantially oval-shaped and said second peg and said second bore are substantially circular in cross section.

10. The artificial insect of claim 1 further comprising:
a plurality of legs extending from said body.

11. The artificial insect of claim 1 further comprising:
two antenna extending from the head end of said body.

12. The artificial insect of claim 1 wherein said one-piece wing component is comprised of a plastic film.

13. The artificial insect of claim 1 wherein said body is composed of plastic.

14. The artificial insect of claim 1 wherein said wing component has a design printed thereon.

15. An artificial insect comprising:
a body having a head end and a tail end, said body having an upper body section and a lower body section and said lower body section having an upper surface defining a cavity with a pair of opposite upwardly angled sidewalls;
said upper body section having a lower surface received within said cavity and defining a pair of opposite upwardly angled sidewalls that cooperate with the upwardly angled sidewalls of said cavity to define a wing-receiving slot;
a one-piece wing component disposed between said lower body section and said upper body section in said wing-receiving slot; and
means for securing said upper body section to said lower body section, said means also affixing said wing component therebetween.

16. The artificial insect of claim 15 wherein said means for securing comprises a peg depending from said upper body section and a bore formed in said lower body section, said peg being press-fit into said bore to secure said upper and lower body sections together.

17. The artificial insect of claim 16 wherein said wing component has an aperture formed therein and said peg extends through said aperture, thereby sandwiching said wing component between said upper body section and said lower body section.

18. The artificial insect of claim 16 wherein said lower body section comprises an abdomen, a lower thorax section, and a lower head section, and said upper body section comprises an upper thorax section and an upper head section.

19. The artificial insect of claim 18 wherein said coupling arrangement comprises:
a first peg depending from said upper thorax section;
a second peg depending from said upper head section;
a first bore formed in said lower thorax section; and
a second bore formed in said lower head section, wherein said first peg is press fit into said first bore and said second peg is press fit into said second bore to couple said upper body section to said lower body section.

20. The artificial insect of claim 19 wherein said wing component has an aperture formed therein and said first peg extends through said aperture, thereby sandwiching said wing component between said upper body section and said lower body section.
